(19) United States
(12) Patent Application Publication
(10) Pub. No.: US 2003/0163739 A1
(43) Pub. Date: Aug. 28, 2003

(54) Robust multi-factor authentication for secure application environments

(76) Inventors: John Phillip Armington, Marietta, GA (US); Purdy PinPin Ho, Boston, MA (US)

Correspondence Address: HEWLETT-PACKARD COMPANY, Intellectual Property Administration, P.O. Box 272400, Fort Collins, CO, 80527-2400, US

(21) Appl. No.: 10/086,123

(22) Filed: Feb. 28, 2002

(51) Int. Cl. H04L 9/00

(52) U.S. Cl. 713/202; 713/186

(57) ABSTRACT

An improved authentication system utilizes multi-factor user authentication. In an exemplary embodiment, one authentication factor is the user's speech pattern, and another authentication factor is a one-time passcode. The speech pattern and the passcode may be provided via voice portal and/or browser input. The speech pattern is routed to a speaker verification subsystem, while the passcode is routed to a passcode validation subsystem. Many other combinations of input types are also possible. For heightened security, the two (or more) authentication factors are preferably, although not necessarily, provided over differing communication channels (i.e., they are out-of-band with respect to each other). If a user is authenticated by the multi-factor process, he is given access to one or more desired secured applications. Policy and authentication procedures may be abstracted from the applications to allow a single sign-on across multiple applications.

### BACKGROUND

Authentication technologies are generally implemented to verify the identity of a user prior to allowing the user access to secured information. Speaker verification is a biometric authentication technology that is often used in both voice-based systems and other types of systems, as appropriate. Voice-based systems may include a voice transmitting/receiving device (such a telephone) that is accessible to a user (through the user's communication device) via a communication network (such as the public switched telephone network). Generally, speaker verification requires an enrollment process whereby a user “teaches” a voice-based system about the user's unique vocal characteristics. Speaker verification may be implemented by at least three general techniques, namely, text-dependent/fixed-phrase, textindependent/unconstrained, and text-dependent/prompted-phrase techniques.

The text-dependent/fixed-phrase verification technique may require a user to utter one or more phrases (including words, codes, numbers, or a combination of one or more of the above) during an enrollment process. Such uttered phrase(s) may be recorded and stored as an enrollment template file. During an authentication session, the user is prompted to utter the same phrase(s), which is then compared to the stored enrollment template file associated with the user's claimed identity. The user's identity is successfully verified if the enrollment template file and the uttered phrase(s) substantially match each other. This technique may be subject to attack by replay of recorded speech stolen during an enrollment process, during an authentication session, or from a database (e.g., the enrollment template file). Further, this technique may be subject to attack by a text-to-speech voice cloning technique (hereinafter “voice cloning”), whereby a person's speech is synthesized (using that person's voice and prosodic features) to utter the required phrase(s).

The text-independent/unconstrained verification technique typically requires a longer enrollment period (e.g., 10-30 seconds) and more training data from each user. This technique typically does not require use of the same phrase(s) during enrollment and authentication. Instead, specific acoustic features of the user's vocal tract are used to verify the identity of the user. Such acoustic features may be determined based on the training data using a speech sampling and noise filtering algorithm known in the art. The acoustic features are stored as a template file. During authentication, the user may utter any phrase and the user's identity is verified by comparing the acoustic features of the user (based on the uttered phrase) to the user's acoustic features stored in the template file. This technique is convenient for users, because anything they say can be used for authentication. Further, there is no stored phrase to be stolen. However, this technique is more computationally intensive and is still subject to an attack by a replay of a stolen recorded speech and/or voice cloning.

The text-dependent/prompted-phrase verification technique is similar to the text-independent/unconstrained technique described above in using specific acoustic features of the user's vocal tract to authenticate the user. However, simple replay attacks, are defeated by requiring the user to repeat a randomly generated or otherwise unpredictable pass phrase (e.g., one-time passcode or OTP) in real time. However, this technique may still be vulnerable to sophisticated voice cloning attacks.

Thus, it is desirable to provide authentication techniques that are more robust and secure than any one of the foregoing techniques.

### SUMMARY

In one exemplary embodiment of an improved authentication system involving multi-factor user authentication. For heightened security, the first authentication factor is received from the user over a first communication channel, and the system prompts the user for the second authentication factor over a second communication channel which is out-of-band with respect to the first communication channel. Where the second channel is itself authenticated (e.g., one that is known, or highly likely, to be under the control of the user), the second factor may be provided over the first communication channel. In another exemplary embodiment, the two (or more) authentication factors are themselves provided over out-of-band communication channels without regard to whether or how any prompting occurs. For example and without limitation, one of the authentication factors might be prompted via an authenticated browser session, and another might be provided via the aforementioned voice portal.

In a common aspect of the aforementioned exemplary embodiments, the system receives a first authentication factor from the user over a first communication channel, and communicates with the user, regarding a second authentication factor, over a second communication channel which is out-of-band with respect to the first. The communication may include prompting the user for the second authentication factor, and/or it may include receiving the second authentication factor. The fact that at least some portion of a challenge-response protocol relating to the second authentication factor occurs over an out-of-band channel provides the desired heightened security.

If a user is authenticated by the multi-factor process, he/she is given access to one or more desired secured applications. Policy and authentication procedures may be abstracted from the applications to allow a single sign on across multiple applications. The foregoing, and still other exemplary embodiments, will be described in greater detail below.

### BRIEF DESCRIPTION OF THE FIGURES

FIG. 1 illustrates a schematic of an exemplary multi-factor authentication system connected to, and providing user authentication for, an application server.

FIG. 2 illustrates an exemplary portal subsystem of the exemplary multi-factor authentication system shown in FIG. 1.

FIG. 3 illustrates an exemplary speaker verification subsystem of the exemplary multi-factor authentication system shown in FIG. 1.

FIG. 4 illustrates a flow chart of an exemplary two-factor authentication process using a spoken OTP for both speaker verification and token authentication.

FIG. 5 illustrates the two-factor authentication process of FIG. 4 in the context of an exemplary application environment.

FIG. 6 illustrates a more detailed exemplary implementation of two-factor authentication, based on speaker verification plus OTP authentication (either voice-provided or Web-based), and capable of shared authentication among multiple applications.

FIG. 7 illustrates an exemplary user enrollment/training process.

### DETAILED DESCRIPTION

A. Multi-Factor Authentication System for Application Server

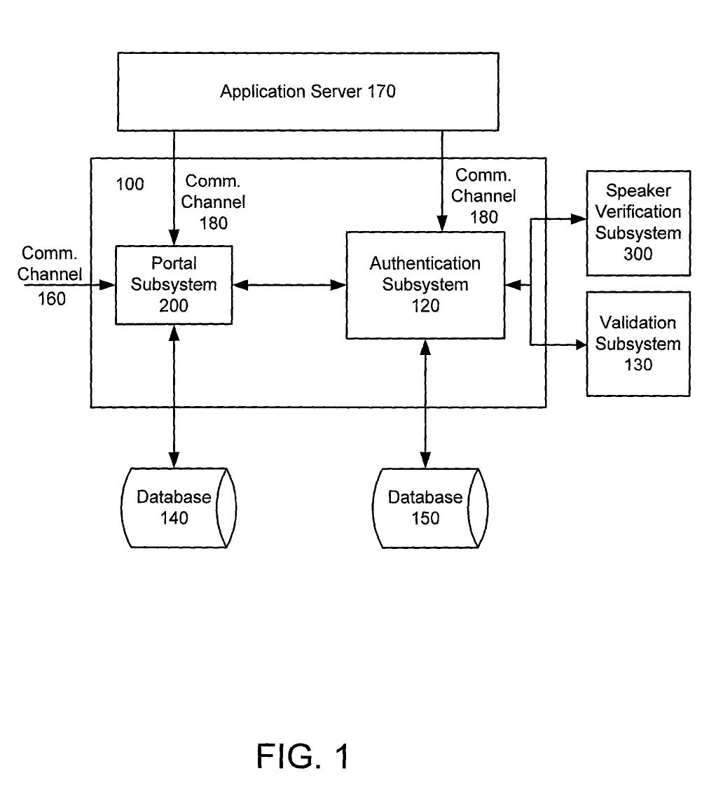

FIG. 1 schematically illustrates the elements of, and signal flows in, a multi-factor authentication system 100, connected to and providing authentication for an application server¹ 170, in accordance with an exemplary embodiment. The exemplary multi-factor authentication system 100 includes a portal subsystem 200 coupled to an authentication subsystem 120. This exemplary authentication system 100 also either includes, or is coupled to, a speaker verification (SV) subsystem 300 and a validation subsystem 130 via the authentication subsystem 120. ¹ Depending on the desired configuration, the authentication system could, of course, be configured as part of the application server.

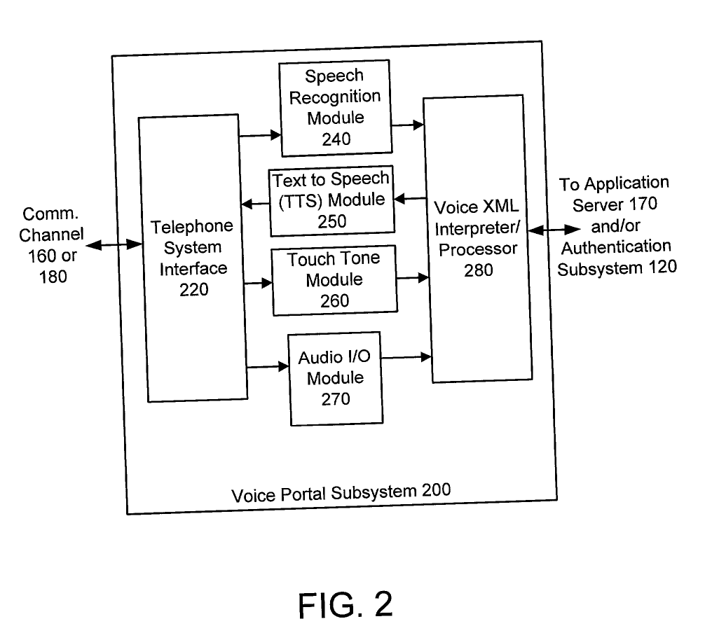

Typically, the portal subsystem 200 has access to an internal or external database 140 that contains user information for performing initial user verification. In an exemplary embodiment, the database 140 may include user identification information obtained during a registration process. For example, the database 140 may contain user names and/or other identifiers numbers (e.g., social security number, phone number, PIN, etc.) associated with each user. An exemplary embodiment of portal subsystem 200 will be described in greater detail below with respect to FIG. 2.

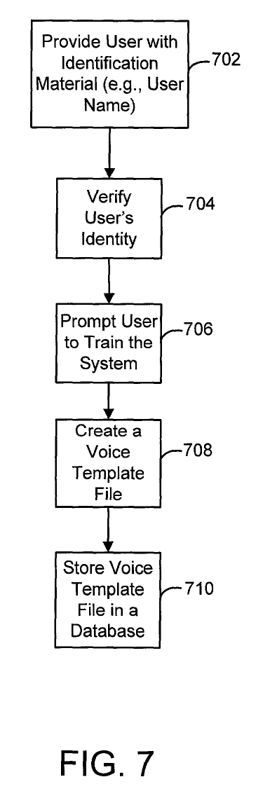

Authentication subsystem 120 also typically has access to an internal or external database 150 that contains user information acquired during an enrollment process. In an exemplary embodiment, the database 140 and database 150 may be the same database or separate databases. An exemplary enrollment process will be described in more detail below with respect to FIG. 7.

The operation of, and relationships among, the foregoing exemplary subsystems will now be described with respect to an exemplary environment in which a user seeking to access an application server is first identified, followed by multiple authentication rounds to verify the user's identity.

B. Preliminary User Identification

Referring to FIG. 1, in one embodiment, the portal subsystem 200 may receive an initial user input via a communication channel 160 or 180. Corresponding to the case where the communication channel is a telephone line, the portal subsystem 200 would be configured as a voice portal. The received initial user input is processed by the portal subsystem 200 to determine a claimed identity of the user using one or more (or a combination of) user identification techniques. For example, the user may manually input her identification information into the portal subsystem 200, which then verifies the user's claimed identity by checking the identification against the database 140. Alternatively, in a telephonic implementation, the portal subsystem 200 may automatically obtain the user's name and/or phone number using standard caller ID technology, and match this information against the database 140. Or, the user may speak her information into portal subsystem 200.

FIG. 2 illustrates one exemplary embodiment of portal subsystem 200. In this exemplary embodiment, a telephone system interface 220 acts as an interface to the user's handset equipment via a communication channel (in FIG. 1, elements 160 or 180), which in this embodiment could be any kind of telephone network (public switched telephone network, cellular network, satellite network, etc.). Interface 220 can be commercially procured from companies such as Dialogic™ (an Intel subsidiary), and need not be described in greater detail herein.

Interface 220 passes signals received from the handset to one or more modules that convert the signals into a form usable by other elements of portal subsystem 200, authentication subsystem 120, and/or application server 170. The modules may include a speech recognition² module 240, a text-to-speech³ (“TTS”) module 250, a touch-tone module 260, and/or an audio I/O module 270. The appropriate module or modules are used depending on the format of the incoming signal. ² Sometimes referred to as a speech-to-text (“SIT”) module. ³ Sometimes referred to as speech simulation or speech synthesis.

Thus, speech recognition module 240 converts incoming spoken words to alphanumeric strings (or other textual forms as appropriate to non-alphabet-based languages), typically based on a universal speaker model (i.e., not specific to a particular person) for a given language. Similarly, touch-tone module 260 recognizes DTMF “touch tones” (e.g., from keys pressed on a telephone keypad) and converts them to alphanumeric strings. In audio I/O module 270, an input portion converts an incoming analog audio signal to a digitized representation thereof (like a digital voice mail system), while the output portion converts a digital signal (e.g., a “.wav” file on a PC) and plays it back to the handset. In this exemplary embodiment, all of these modules are accessed and controlled via an interpreter/processor 280 implemented using a computer processor running an application programmed in the Voice XML programming language.⁴ ⁴ Voice XML is merely exemplary. Those skilled in the art will readily appreciate that other languages, such as plain XML, Microsoft's SOAP, and a wide variety of other well known voice programming languages (from HP and otherwise), can also be used.

In particular, Voice XML interpreter/processor 280 can interpret Voice XML requests from a calling program at the application server 170 (see FIG. 1), execute them against the speech recognition, text-to-speech, touch tone, and/or audio I/O modules and returns the results to the calling program in terms of Voice XML parameters. The Voice XML interpreter/processor 280 can also interpret signals originating from the handset, execute them against modules 240-270, and return the results to application server 170, authentication subsystem 120, or even handset.

Voice XML is a markup language for voice applications based on eXtensible Markup Language (XML). More particularly, Voice XML is a standard developed and supported by The Voice XML Forum (http://www.voicexml.org/), a program of the IEEE Industry Standards and Technology Organization (IEEE-ISTO). Voice XML is to voice applications what HTML is to Web applications. Indeed, HTML and Voice XML can be used together in an environment where HTML displays Web pages, while Voice XML is used to render a voice interface, including dialogs and prompts.

Returning now to FIG. 1, after portal subsystem 200 converts the user's input to an alphanumeric string, it is passed to database 140 for matching against stored user profiles. No matter how the user provides her identification at this stage, such identification is usually considered to be preliminary, since it is relatively easy for impostors to provide the identifying information (e.g., by stealing the data to be inputted, gaining access to the user's phone, or using voice cloning technology to impersonate the user). Thus, the identity obtained at this stage is regarded as a “claimed identity” which may or may not turn out to be valid—as determined using the additional techniques described below.

For applications requiring high-trust authentication, the claimed identity of the user is passed to authentication subsystem 120, which performs a multi-factor authentication process, as set forth below.

C. First Factor Authentication

The authentication subsystem 120 prompts the user to input an authentication sample (more generally, a first authentication factor) for the authentication process via the portal subsystem 200 from communication channel 160 or via communication channel 180.

The authentication sample may take the form of biometric data⁵ such as speech (e.g., from communication channel 160 via portal 200), a retinal pattern, a fingerprint, handwriting, keystroke patterns, or some other sample inherent to the user and thus not readily stolen or counterfeited (e.g., via communication channel 180 via application server 170). ⁵ Biometric data is preferred because it is not only highly secure, but also something that the user always has. It is, however, not required. For example, in less secure applications or in applications allowing a class of users to share a common identity, the first authentication factor could take the form of non-biometric data.

Suppose, for illustration, that the authentication sample comprises voice packets or some other representation of a user's speech. The voice packets could be obtained at portal subsystem 200 using the same Voice XML technology described earlier, except that the spoken input typically might not be converted to text using a universal speech recognition module, but rather passed on via the voice portal's audio I/O module for comparison against user-specific voice templates.

For example, the authentication subsystem 120 could retrieve or otherwise obtain access to a template voice file associated with the user's claimed identity from a database 150. The template voice file may have been created during an enrollment process, and stored into the database 150. In one embodiment, the authentication subsystem 120 may forward the received voice packets and the retrieved template voice file to speaker verification subsystem 300.

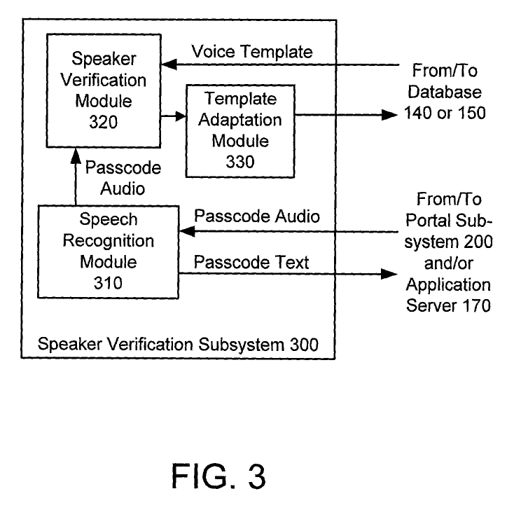

FIG. 3 illustrates an exemplary embodiment of the speaker verification subsystem 300. In this exemplary embodiment, speech recognition module 310 converts the voice packets to an alphanumeric (or other textual) form, while speaker verification module 320 compares the voice packets against the user's voice template file. Techniques for speaker verification are well known in the art (see, e.g., SpeechSecure from SpeechWorks, Verifier from Nuance, etc.) and need not be described in further detail here). If the speaker is verified, the voice packets may also be added to the user's voice template file (perhaps as an update thereto) via template adaptation module 330.

The foregoing assumes that the user's voice template is available, for example, as a result of having been previously generated during an enrollment process. An exemplary enrollment process will be described later, with respect to FIG. 7.

Returning now to FIG. 1, if the speaker verification server 300 determines that there is a match (within defined tolerances) between the speech and the voice template file, the speaker verification subsystem 300 returns a positive result to the authentication subsystem 120.

If other forms of authentication samples are provided besides speech, other user verification techniques could be deployed in place of speaker verification subsystem 300. For example, a fingerprint verification subsystem could use the Match-On-Card smartcard from Veridicom/Gemplus, the “U. are U.” product from DigitalPersona, etc. Similarly, an iris/retinal scan verification subsystem could use the Iris Access product from Iridian Technologies, the Eyedentification 7.5 product from EyeDenitify, Inc.. These and still other commercially available user verification technologies are well known in the art, and need not be described in detail herein.

D. Second Factor Authentication

In another aspect of an exemplary embodiment of the multi-factor authentication process, the authentication subsystem 120 also prompts the user to speak or otherwise input a secure passcode (e.g., an OTP) (more generally, a second authentication factor) via the portal subsystem 200. Just as with the user's claimed identity, the secure passcode may be provided directly (e.g., as an alphanumeric string), or via voice input.

In the case of voice input, the authentication subsystem 120 would convert the voice packets into an alphanumeric (or other textual) string that includes the secure passcode. For example, the authentication subsystem 120 could pass the voice sample to speech recognition module 240 (see FIG. 2) or 310 (see FIG. 3) to convert the spoken input to an alphanumeric (or other textual) string.

In an exemplary secure implementation, the secure passcode (or other second authentication factor) may be provided by the user to the system via a secure channel that is out-of-band (with respect to the channel over which the authentication factor is presented by the user) such as channel 180. Exemplary out-of-band channels might include a secure connection to the application server 170 (via a connection to the user's Web browser), or any other input that is physically distinct (or equivalently secured) from the channel over which the authentication factor is presented.

In another exemplary secure implementation, the out-of-band channel might be used to prompt the user for the secure passcode, where the secure passcode may thereafter be provided over the same channel over which the first authentication factor is provided.⁶ In this exemplary implementation, it is sufficient to only prompt—without (necessarily) requiring that the user provide—the second authentication factor over the second channel provided that the second channel is trusted (or, effectively, authenticated) in the sense of being most likely controlled by the user. For example, if the second channel is a phone uniquely associated with the user (e.g., a residence line, a cell phone, etc.) it is likely that that the person answering the phone will actually be the user. Other trusted or effectively authenticated channels might include, depending on the context, a physically secure and access-controlled facsimile machine, an email message encrypted under a biometric scheme or otherwise decryptable only by the user, etc. ⁶ Of course, the second authentication factor could also be provided over the second communication channel. This provides even greater security; however, it may be less convenient or less desirable depending on the particular user environment in which the system is deployed.

In either exemplary implementation, by conducting at least a portion of a challenge-response communication regarding the second authentication factor over an out-of-band channel, the heightened security of the out-of-band portion of the communication is leveraged to the entire communication.

In another aspect of the second exemplary implementation, the prompting of the user over the second communication channel could also include transmitting a secure passcode to the user. The user would then be expected to return the secure passcode during some interval during which it is valid. For example, the system could generate and transmit an OTP to the user, who would have to return the same OTP before it expired. Alternatively, the user could have an OTP generator matching an OTP generator held by the system.

There are many schemes for implementing one-time passcodes (OTPs) and other forms of secure passcodes. For example, some well-known, proprietary, token-based schemes include hardware tokens such as those available from RSA (e.g., SecurID) or ActivCard (e.g., ActivCard Gold). Similarly, some well-known public domain schemes include S/Key or Simple Authentication and Security layer (SASL) mechanisms. Indeed, even very simple schemes may use email, fax or perhaps even post to securely send an OTP depending on bandwidth and/or timeliness constraints. Generally, then, different schemes are associated with different costs, levels of convenience, and practicalities for a given purpose. The aforementioned and other OTP schemes are well understood in the art, and need not be described in more detail herein.

E. Combined Operation

The exemplary preliminary user identification, first factor authentication, and second factor authentication processes⁷ described above can be combined to form an overall authentication system with heightened security. ⁷ For convenience, we illustrate combining two authentication factors. Those skilled in the art will readily appreciate that a more general multi-factor authentication system could include more than two factors.

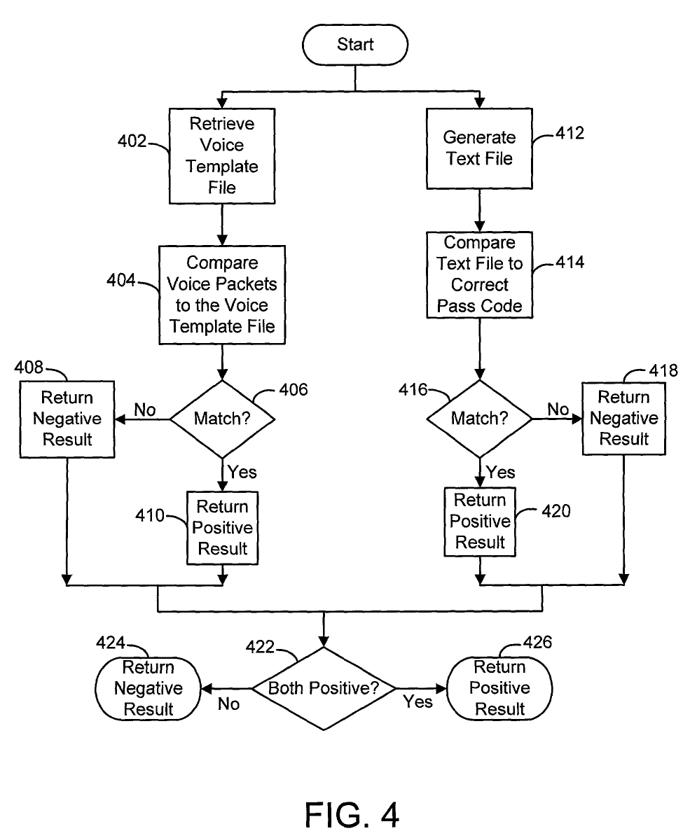

FIG. 4 illustrates one such exemplary embodiment of operation of a combined system including two-factor authentication with preliminary user identification. This embodiment illustrates the case where both user authentication inputs (biometric data, plus secure passcode) are provided in spoken form.

The authentication inputs may be processed by two sub-processes. In the first sub-process, a voice template file associated with the user's claimed identity (e.g., a file created from the user's input during an enrollment process) may be retrieved (step 402). Next, voice packets from the authentication sample may be compared to the voice template file (step 404). Whether the voice packets substantially match the voice template file within defined tolerances is determined (step 406). If no match is determined, a negative result is returned (step 408). If a match is determined, a positive result is returned (step 410).

In the second sub-process⁸, an alphanumeric (or other textual) string (e.g., a file including the secure passcode) may be computed by converting the speech to text (step 412). For example, if the portal subsystem 200 of FIG. 2 is used, the user-inputted passcode would be converted to an alphanumeric (or other textual) string using speech recognition module 240 (for voice input) or touch tone module 260 (for keypad input). Next, the alphanumeric (or other textual) string may be compared to the correct pass code (either computed via the passcode algorithm or retrieved from secure storage) (step 414). Whether the alphanumeric (or other textual) string substantially matches the correct passcode is determined (step 416). If no match is determined, a negative result is returned (step 418). If a match is determined, a positive result is returned (step 420). ⁸ The first and the second sub-processes may be performed substantially concurrently or in any sequence.

The results from the first sub-process and the second sub-process are examined (step 422). If either result is negative, the user has not been authenticated and a negative result is returned (step 424). If both results are positive, the user is successfully authenticated and a positive result is returned (step 426).

F. Combined Authentication in Exemplary Application Environments

1. Process Flow Illustration

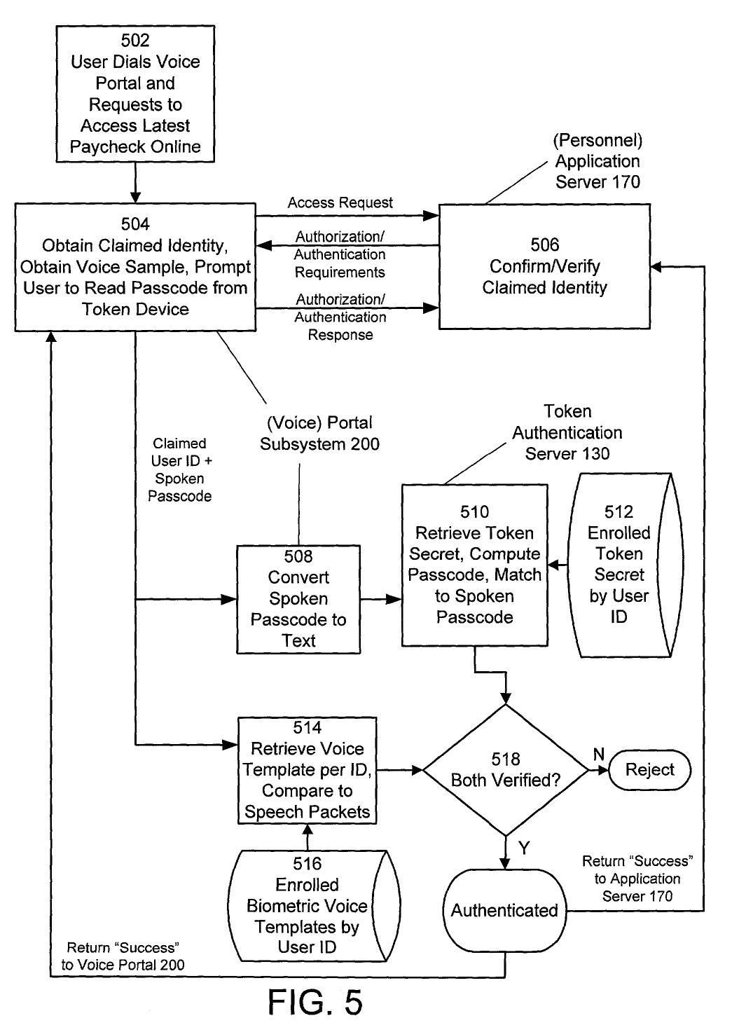

FIG. 5 illustrates an exemplary two-factor authentication process of FIG. 4 in the context of an exemplary application environment involving voice input for both biometric and OTP authentication. This exemplary process is further described in a specialized context wherein the user provides the first authentication factor over the first communication channel, is prompted for the second authentication factor over the second communication channel, and provides the second authentication factor over the first communication channel.⁹ ⁹ Those skilled in the art will readily appreciate how to adapt the illustrated process to a special case of the other aforementioned exemplary environment (different authentication factors over different communication channels) provided that the two channels are of the same type (e.g., both voice-based) even though they are out-of-band with respect to each other (e.g., one might be a land line, the other a cell phone).

The user connects to portal subsystem 200 and makes a request for access to the application server 170 (step 502). For example, the user might be an employee accessing her company's personnel system (or a customer accessing her bank's account system) to request access to the direct deposit status of her latest paycheck.

The portal solicits information (step 504) for: (a) preliminary identification of the user; (b) first factor (e.g., biometric) authentication; and (c) second factor (e.g., secure passcode or OTP) authentication. For example: (a) the portal could obtain the user's claimed identity (e.g., an employee ID) as spoken by the user; (b) the portal could obtain a voice sample as the user speaks into the portal; and (c) the portal could obtain the OTP as the user reads it from a token held by the user.

The voice sample in (b) could be taken from the user's self-identification in (a), from the user's reading of the OTP in (c), or in accordance with some other protocol. For example, the user could be required to recall a pre-programmed string, or to respond to a variable challenge from the portal (e.g., what is today's date?), etc.¹⁰ ¹⁰ The fact that the voice sample could be taken from the user's reading of the OTP illustrates that the user need not have provided the first authentication factor (e.g., voice sample) prior to being prompted for the second authentication factor (e.g., OTP). For example, if both authentication factors are provided simultaneously, the prompting should occur prior to the user's providing both authentication factors. Indeed, the first authentication factor need not precede the second authentication factor. Therefore, the user should understand that the labels “first” and “second” are merely used to differentiate the two authentication factors, rather than to require a temporal relationship. Indeed, as illustrated here, the two authentication factors can even be provided via a common vehicle (e.g., as part of a single spoken input).

As step 506, the portal could confirm that the claimed identity is authorized by checking for its presence (and perhaps any associated access rights) in the (company) personnel or (bank) customer application. Optionally, the application could include an authentication process of its own (e.g., recital of mother's maiden name, social security number, or other well-known challenge-response protocols) to preliminarily verify the user's claimed identity. This preliminary verification could either occur before, or after, the user provides the OTP.

The user-recited OTP is forwarded to a speech recognition module (e.g., element 240 of FIG. 2) (step 508).

Validation subsystem 130 (e.g., a token authentication server) (see FIG. 1) computes an OTP to compare against what is on the user's token (step 510).¹¹ If (as in many common OTP implementations), computation of the OTP requires a seed or ‘token secret’ that matches that in the user's token device, the token secret is securely retrieved from a database (step 512). The token authentication server then compares the user-recited OTP to the generated OTP and reports whether there is or is not a match. ¹¹ This exemplary process flow illustrates the situation where the user has an OTP generator. Those skilled in the art will readily appreciate how the exemplary process flow can be adapted to an implementation where the user-returned OTP is one that has previously been transmitted by the system to the user.

The user-recited OTP (or other voice sample, if the OTP is not used as the voice sample) is also forwarded to speaker verification module (e.g., element 320 of FIG. 2). The speaker verification module 320 retrieves the appropriate voice template, compares it to the voice sample, and reports whether there is (or is not) a match (step 514). The voice template could, for example, be retrieved from a voice template database, using the user ID as an index thereto (step 516).

If both the OTP and the user's voice are verified, the user is determined to be authenticated, “success” is reported to application server 170 (for example, via the voice portal 200), and the user is allowed access (in this example, to view her paycheck information) (step 518). If either the OTP or the user's voice is not authenticated, the user is rejected and, optionally, prompted to retry (e.g., until access is obtained, the process is timed-out, or the process is aborted as a result of too many failures). Whether or not access is allowed, the user's access attempts may optionally be recorded for auditing purposes.

2. System Implementation Illustration

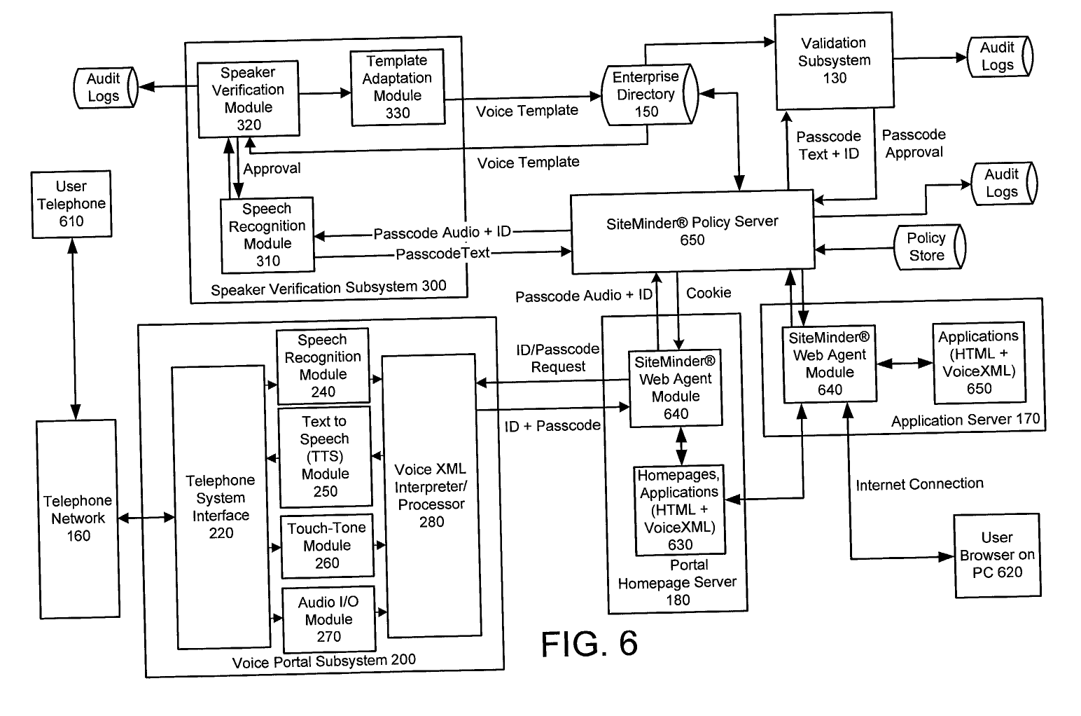

FIG. 6 illustrates another more detailed exemplary implementation of two-factor authentication, based on speaker verification (e.g., a type of first factor authentication), plus OTP authentication (e.g., a type of second factor authentication). In addition, the overall authentication process is abstracted from the application server 170, and is also shareable among multiple applications.

During an enrollment process, the user's voice template is obtained and stored under her user ID. Also, the user is given a token card (OTP generator), which is also enrolled under her user ID.

To begin a session, the user calls into the system from her telephone 610. The voice portal subsystem 200 greets her and solicits her choice of applications. The user specifies her choice of application per the menu of choices available on the default homepage for anonymous callers (at this point the caller has not been identified). If her choice is one requiring authenticated identity, the system solicits her identity. If her choice is one requiring high-security authentication of identity, the system performs strong two-factor authentication as described below. The elements of voice portal subsystem are as shown in FIG. 6: a telephone system interface 220, a speech recognition module 240, a TTS module 250, a touch-tone module 260, and an audio I/O module 270. A Voice XML interpreter/processor 280 controls the foregoing modules, as well as interfacing with the portal homepage server 180 and, through it, downstream application servers 170.¹² ¹² In the illustrated implementation, a portal homepage server acts as communication channel 180 over which communications are routed to/from application server 170. More generally, of course, the functionality of portal homepage server 180 could be implemented as part of application server 170.

In this exemplary embodiment, once the user's claimed identity is determined, the portal homepage server 180 checks the security (i.e., access) requirements of the her personal homepage as recorded in the policy server 650, performs any necessary preliminary authentication/authorization (e.g., using the techniques mentioned in step 506 of FIG. 5), and then speaks, displays, or otherwise makes accessible to her, a menu of available applications. In a purely voice-based user-access configuration, the menu could be spoken to her by TTS module 250 of the voice portal subsystem 200. If the user has a combination of voice and Web access, the menu could be displayed to her over a browser 620.

Returning now to FIG. 6, in this exemplary implementation, middleware in the form of Netegrity's SiteMinder product suite is used to abstract the policy and authentication from the various applications. This abstraction allows a multi-application (e.g., stock trading, bill paying, etc.) system to share an integrated set of security and management services, rather than building proprietary user directories and access control systems into each individual application. Consequently, the system can accommodate many applications using a “single sign-on” process.¹³ ¹³ In the exemplary implementation described in FIG. 6, the authentication is abstracted from the application server by the use of a Web agent 640 and policy server 650. If such abstraction is not desired, the functions performed by those elements would be incorporated into, and performed within, application server 170.

Each application server 170 has a SiteMinder Web agent 640 in the form of a plug-in module, communicating with a shared Policy Server 650 serving all the application servers. Each server's Web agent 640 mediates all the HTTP (HTML XML, etc.) traffic on that server.¹⁴ The Web agent 640 receives the user's request for a resource (e.g., the stock trading application), and determines from policy store that it requires high trust authentication. Policy server 650 instructs Web agent 640 to prompt the user to speak a one-time passcode displayed on her token device. If the second channel is also a telephone line, the prompting can be executed via a Voice XML call through Voice XML interpreter/processor 280 to invoke TTS module 250. If the second channel is the user's browser, the prompting would be executed by the appropriate means. ¹⁴ A web agent module also performs similar functions in portal homepage server 180.

Web agent 640 then posts a Voice XML request to the voice portal subsystem 200 to receive the required OTP. The voice portal subsystem 200 then returns the OTP to the Web agent 640, which passes it to the policy server 650. Depending on system configuration, the OTP may either be converted from audio to text within speech recognition module 240, and passed along in that form, or bypass speech recognition module 240 and be passed along in audio form. The former is sometimes performed in a universal speech recognition process (e.g., speech recognition module 240) where the OTP is relatively simple and/or not prone to mispronunciation.

However, as illustrated in FIG. 6, it is often preferable to use a speaker-dependent speech recognition process for greater accuracy. In that case, policy server 650 could forward the user ID and OTP to speaker verification subsystem 300. As was described with respect to FIG. 3, speaker verification subsystem 300 retrieves the user's enrolled voice template from a database (e.g., enterprise directory) 150, and speech recognition module 310 uses the template to convert the audio to text. In either case, the passcode is then returned in text form to the policy server 650, which forwards it to the passcode validation subsystem 130.

Policy server 650 can forward the user ID and OTP (if received in textual form) to passcode authentication verification server 130 without recourse to speaker verification subsystem 300. Alternatively, as necessary, policy server 650 can utilize part of all of voice portal subsystem 200 and/or speaker verification subsystem 300 to perform any necessary speech-text conversions.

If the validation subsystem 130 approves the access (as described earlier in Section F.1), it informs policy server 650 that the user has been authenticated and can complete the stock transaction. The validation subsystem 130 or policy server 650 may also create an encrypted authentication cookie and pass it back to the portal homepage server 180.¹⁵ ¹⁵ Or directly to application server 170, depending on the particular configuration.

The authentication cookie can be used in support of further authentication requests (e.g., by other applications), so that the user need not re-authenticate herself when accessing multiple applications during the same session. For example, after completing her stock trade, the user might select a bill-pay application that also requires high-trust authentication. The existing authentication cookie is used to satisfy the authentication policy of the bill-pay application, thus saving the user having to repeat the authentication process. At the end of the session (i.e., when no more applications are desired), the cookie can be destroyed.

G. User Enrollment

It is typically necessary to have associated the user's ID with the user's token prior to authentication. Similarly, the user's voice sample was compared to the user's voice template during speaker verification. Hence, it is typically necessary to have associated recorded a voice template for the user prior to authentication. Both types of associations, of the user with the corresponding authentication data, are typically performed during an enrollment process (which, of course, may actually comprise a composite process addressing both types of authentication data, or separate processes as appropriate). Thus, secure enrollment plays a significant role in reducing the likelihood of unauthorized access by impostors.

FIG. 7 illustrates an exemplary enrollment process for the voice template portion of the example shown above. This exemplary enrollment process includes a registration phase and a training phase.

In an exemplary registration step in which a user is provided a user ID and/or or other authentication material(s) (e.g., a registration passcode, etc.) for use in the enrollment session (step 702). Registration materials may be provided via an on-line process (such as e-mail) if an existing security relationship has already been established. Otherwise, registration is often done in an environment where the user can be personally authenticated. For example, if enrollment is performed by the user's employer, then simple face-to-face identification of a known employee may be sufficient. Alternatively, if enrollment is outsourced to a third party organization, the user might be required to present an appropriate form(s) of identification (e.g., passport, driver's license, etc.).

The user may then use the user ID and/or other material(s) provided during registration to verify her identity (step 704) and proceed to voice template creation (step 708).

Typically, the user is prompted to repeat a series of phrases into the system to “train” the system to recognize her/her unique vocal characteristics (step 706).

A voice template file associated with the user's identity is created based on the user repeated phrases (step 708). For example, the user's voice may be processed by a speech sampling and noise-filtering algorithm, which breaks down the voice into phonemes to be stored in a voice template file.

The voice template file is stored in a database for use later during authentication sessions to authenticate the user's identity (step 710).

H. Conclusion

In all the foregoing descriptions, the various subsystems, modules, databases, channels, and other components are merely exemplary. In general, the described functionality can be implemented using the specific components and data flows illustrated above, or still other components and data flows as appropriate to the desired system configuration. For example, although the system has been described in terms of two authentication factors, even greater security could be achieved by using three or more authentication factors. In addition, although the authentication factors were often described as being provided by specific types of input (e.g., voice), they could in fact be provided over virtually any type of communication channel. It should also be noted that, the labels “first” and “second” are not intended to denote any particular ordering or hierarchy. Thus, techniques or cases described as “first” could be used in place of techniques or cases described as “second,” or vice-versa. Those skilled in the art will also readily appreciate that the various components can be implemented in hardware, software, or a combination thereof. Thus, the foregoing examples illustrate certain exemplary embodiments from which other embodiments, variations, and modifications will be apparent to those skilled in the art. The inventions should therefore not be limited to the particular embodiments discussed above, but rather is defined by the claims.

I claim:

1. A method for authenticating a user, comprising the steps of:
(a) receiving a claimed identity of a user;
(b) receiving a first authentication sample from said user via a first communication channel;
(c) establishing a second communication channel with said user;
(i) said second communication channel being out-of-band with respect to said first communication channel;
(d) performing at least a portion of a challenge-response protocol, regarding a second authentication sample, with said user over said second communication channel;
(e) verifying at least one of said first and second authentication samples based on a stored template uniquely associated with said claimed identity;
(f) verifying another of said authentication samples in a manner independent of said verifying in (d); and
(g) granting access to said user based on said verifying in steps (e) and (f).

2. The method of claim 1, wherein said step (d) includes:
(1) prompting said user via said second communication channel to provide at least one of said authentication samples; and
(2) receiving said prompted authentication sample via said first communication channel.

3. The method of claim 1:
(1) wherein at least one of said authentication samples is spoken; and
(2) further comprising converting said spoken authentication sample into textual form via the application of speech recognition techniques.

4. The method of claim 1:
(1) wherein at least one of said authentication samples is spoken; and
(2) said (e) includes authenticating a unique vocal characteristic of said user by applying a speaker verification protocol involving (i) said claimed identity, (ii) said template, and (iii) said spoken authentication sample.

5. The method of claim 1 further comprising updating a template database based on at least one of said verified authentication samples.

6. The method of claim 1 where said first communication channel is telephonic and said second communication channel is a computer network.

7. The method of claim 1:
(1) where said first and said second authentication samples are provided in spoken form; and
(2) further comprising converting at least one of said spoken authentication samples to textual form for verification.

8. The method of claim 1 where at least one of said authentication samples is a biometric attribute.

9. The method of claim 1 where at least one of said authentication samples is a dynamically changing attribute held by said user.

10. The method of claim 1, wherein said step (a) includes the step of determining a telephonic caller identification of said user.

11. The method of claim 1, wherein said step (f) includes the steps of:
(1) generating a first string based on said another authentication sample;
(2) independently generating a second string based on said claimed identity;
(3) digitally comparing said first and second strings; and
(4) authenticating said another authentication sample if said strings match.

12. The method of claim 1 further comprising enabling a single sign-on process by sharing said authentication across multiple applications requiring authentication during a common session.

13. A method for authenticating a user, comprising the steps of:
(a) receiving a claimed identity of a user;
(b) receiving a first authentication sample from said user via a first communication channel;
(c) receiving a second authentication sample from said user via a second communication channel;
(d) verifying at least one of said first and second authentication samples based on a stored template uniquely associated with said claimed identity; and
(e) verifying another of said authentication samples in a manner independent of said verifying in (d); and
(f) granting access to said user based on said verifying in steps (d) and (e).

14. The method of claim 13:
(1) where said second communication channel is out-of-band with respect to said first communication channel; and
(2) further comprising, between said steps (a) and (c), prompting said user to use said second communication channel in response to determining that said first communication channel is insufficiently secure for the application environment.

15. A method for authenticating a user, comprising the steps of:
(a) obtaining a claimed identity of a user to be authenticated;
(b) prompting a user to speak a secure passcode via a communication channel;
(c) biometrically authenticating said user's voice by:
(i) obtaining a stored vocal characteristic unique to said claimed identity,
(ii) extracting a vocal characteristic of said user based on said spoken secure passcode, and
(iii) comparing said stored vocal characteristic and said extracted vocal characteristic;
(d) authenticating said secure passcode by:
(i) obtaining a regenerated passcode corresponding to said claimed identity, and
(ii) comparing said regenerated passcode and said spoken passcode; and
(e) granting access to said user if said user's voice and said passcode are authenticated based on steps (c) and (d).

16. A system for providing access to a secure application after user authentication, comprising:
(a) a portal subsystem configured to:
(i) receive a first user authentication sample via a first communication channel,
(ii) authenticate said first authentication sample via a biometric process;
(b) an authentication subsystem coupled to:
(i) said portal subsystem, and
(ii) a second communication channel which is out-of-band with respect to said first communication channel;
(c) said authentication subsystem being configured to:
(i) prompt a user via said portal subsystem to provide a sample over said second communication channel,
(ii) receive said second authentication sample via said second communication channel, and
(iii) authenticate said second authentication sample; and
(d) an application server:
(i) connected to said portal subsystem and said authentication subsystem, and
(ii) providing access to said user upon successful authentication of both said first and second authentication samples.

17. A system for providing user authentication to control access to a protected application, comprising:
(a) an interface, configured to receive a claimed identity of a user;
(b) an interface, connected to a first communication path, configured to receive a first authentication datum associated with said user;
(c) an interface, connected to a second communication path to said user which is out-of-band with respect to said first communication path;
(d) means for performing, over said second communication path, at least a portion of a challenge-response communication regarding a second authentication datum associated with said user;
(e) means for verifying said first authentication datum based on a nominal identity of said user; and
(f) means for verifying said second authentication datum independently of (e); and
(g) means for granting access to said user after both authentication data are verified.

18. The system of claim 17, where (d) further comprises means for prompting said user via said second communication path to provide said second authentication sample via said first communication path.

19. The system of claim 17 where said first communication path is telephonic and said second communication path is a computer network.

20. The system of claim 17:
(1) where both authentication data are received in oral form; and
(2) further comprising a speech-to-text module configured to convert at least one of said authentication data to textual form for verification.

21. A system for providing user authentication to control access to a protected application, comprising:
(a) means for prompting a user to speak a secure passcode to a system interface;
(b) a biometric authenticator configured to:
(i) extract a prosodic feature of said user based on said spoken secure passcode, and
(iii) verify said extracted prosodic feature against a stored prosodic template of said user;
(d) a passcode authenticator configured to:
(i) regenerate a passcode corresponding to said spoken passcode, and
(ii) verify said regenerated passcode against said spoken passcode; and
(e) means for granting access to said user after authenticating said user's voice and said passcode.

22. A computer-readable medium for authenticating a user, comprising logic instructions that, if executed:
(a) receive a claimed identity of a user;
(b) receive a first authentication sample from said user via a first communication path;
(c) establish a second communication path with said user;
(i) said second authentication path being out-of-band with respect to said first communication path;
(e) perform at least a portion of a challenge-response protocol, regarding a second authentication sample, with said user over said second communication path;
(e) verify at least one of said first and second authentication samples based on a stored template uniquely associated with said claimed identity; and
(f) verify another of said authentication samples in a manner independent of said verifying in (e); and
(g) grant access to said user based on said verification in (e) and (f).

23. The system of claim 22, wherein at least one of said means for receiving includes:
(1) means for prompting said user via said first communication channel to provide at least one of said authentication samples; and
(2) means for receiving said prompted authentication sample via said second communication channel.

24. The computer-readable medium of claim 22 where said first communication channel is telephonic, and said second communication channel is a computer network.

25. The computer-readable medium of claim 22:
(1) where said first and said second authentication samples are in spoken form; and
(2) further comprising logic instructions that, if executed, convert at least one of said spoken authentication samples to textual form for verification.

26. A computer-readable medium for authenticating a user, comprising logic instructions that, if executed:
(a) obtain a claimed identity of a user to be authenticated;
(b) prompt a user to speak a secure passcode via a communication channel;
(c) biometrically authenticate said user's voice by:
(i) obtaining a stored vocal characteristic unique to said claimed identity,
(ii) extracting a vocal characteristic of said user based on said spoken secure passcode, and
(iii) comparing said stored vocal characteristic and said extracted vocal characteristic;
(d) authenticate said secure passcode by:
(i) obtaining a regenerated passcode corresponding to said claimed identity, and
(ii) comparing said regenerated passcode and said spoken passcode; and
(e) grant access to said user if said user's voice and said passcode are authenticated based on (c) and (d).
